(19) United States
(12) Patent Application Publication
(10) Pub. No.: US 2011/0122820 A1
(43) Pub. Date: May 26, 2011

(54) SYSTEM OPERABLE TO ENABLE MOBILE ACCESS

(76) Inventor: Per Bergqvist, Mamer (LU)

(21) Appl. No.: 13/003,226

(22) PCT Filed: Jun. 18, 2009
(86) PCT No.: PCT/SE09/50775

§ 371 Date: Jan. 7, 2011

(30) Foreign Application Priority Data
Jul. 8, 2008 (EP) 08159871.6

(51) Int. Cl. H04W 8/24; H04W 40/00

(52) U.S. Cl. 370/328; 455/418; 455/406

(57) ABSTRACT

The present invention relates to a system (10) operable to enable mobile access for a mobile computer means (12), comprised in the system (10), to a cellular network (14) or a distributed computer network (18). The system (10) also comprises an interface means (18) operable to exchange configuration data for the cellular network (14) between a mobile memory means (20) comprised in the system (10) and the mobile computer means (12). The mobile computer means (12) comprises a client means (22) operable to retrieve the configuration data, whereby the mobile computer means (12) is operable to automatically set up a connection to e.g. the distributed computer network (16).

### FIELD OF THE INVENTION

The present invention relates in a first aspect to a system operable to enable mobile access for a mobile computer means to a cellular network or a distributed computer network.

According to a second aspect the present invention relates to a method for enabling mobile access for a mobile computer means to a cellular network or a distributed computer network.

According to a third aspect the present invention relates to at least one computer program product for enabling mobile access for a mobile computer means to a cellular network or a distributed network.

### BACKGROUND OF THE INVENTION

In the world of today it is quite common that people travel to other countries as tourists or for business reasons bringing with them their computers that are connected to the Internet using the cellular networks. Normally, it is predictable to know the costs of transferring data to or from the computer using the cellular network. However, when roaming in to another operator the cost of transferring data are not predictable any more. Furthermore, the configuration and set up of the cellular modem is sometimes also not performed flawlessly.

The current solution to the problems described above is that a manual configuration is necessary which configuration is error prone. It is also possible in some cases that the actual necessary configuration is not possible to perform due to missing functionality in the computer or SIM card.

The patent document US-2007/0121284 relates to a laptop-style computer that incorporates the usage of memory cards in general and also the usage of a SIM card that is used in order to enable the usage of a communicator. The document teaches nothing about how the communication between the SIM card and the laptop is set up or how the SIM card communicates with the mobile/wireless network.

The patent document US-2008/0133708 relates to the sharing of information with other users through context based recognition whereby third-parties may contact a user via the most appropriate means of communication at any given time as reflected by status information.

It describes mainly a client-server system where configuration data is stored in the server. Furthermore, it describes the usage of WAP push as a mean for fetching data from the mobile device.

The U.S. Pat. No. 6,496,689 B1 relates to indication of charging information using the USSD mechanism. To achieve an improved overview on service charges for a subscriber to a digital cellular communication network it is proposed to provide a mobile station with a charging indication unit adapted to receive charging information as unstructured supplementary service data messages (USSD) via the unstructured supplementary service data dialog. Further, as more detailed information on the kind of service and on the amount of data transferred is available a detailed estimate on the actual cost that may be displayed to the user of the mobile station.

The patent document US-2007/0256135 A1 relates to a way of securing access to a WLAN for a dual mode device (WLAN and, for example GSM).

The patent document US-2004/0127204 A1 relates to a method and apparatus to establish communication. The method to establish a connection to a local area network is performed by configuring a mobile unit (MU) of a wireless local area network (WLAN) parameters. The configuration may be performed by using a telecommunication system messaging service to exchange the configuration information between the mobile unit and a public access point (AP) of the WLAN.

The patent document US-2002/0078185 A1 relates to configuration of WLAN parameters for a mobile unit where the parameters are sent to the unit using SMS, OTA or similar.

The patent document EP-1,538,856 A1 relates to a method and system for automatically configuring a device in a communication network. The method involves detecting a need for configuration of a communication apparatus, e.g. laptop computer, based on the presence or absence of events stored in an identification card, e.g. subscriber identity module (SIM) card. The need for configuration is detected after determining whether the apparatus has already been identified by the card, or whether the apparatus is already configured.

### SUMMARY OF THE INVENTION

The above mentioned problems are solved by a system operable to enable mobile access according to Claim 1. The system is operable to enable mobile access for a mobile computer means, comprised in the system, to a cellular network or a distributed computer network. The system also comprises an interface means operable to exchange configuration data for the cellular network between a mobile memory means, comprised in the system, and the mobile computer means. The mobile computer means comprises a client means operable to retrieve the configuration data, whereby the mobile computer means is operable to automatically set up a connection to e. g. the distributed computer network.

An advantage with the system according to the present invention is that it makes it possible for the user of the computer to access e. g. the Internet in a predictable way.

A further advantage in this context is achieved if the interface means comprises a configuration means operable to exchange the configuration data, and if the client means comprises a configuration client means operable to retrieve the configuration data.

Furthermore, it is an advantage in this context if the interface means also comprises a cost plan means operable to exchange cost plan data between the mobile memory means and the mobile computer means, and if the client means also comprises a cost plan client means operable to retrieve the cost plan data.

By this it will be possible for the user to always be connected independent of location without the need to worry about the cost for accessing e.g. the Internet.

A further advantage in this context is achieved if the interface means also comprises a current cost means operable to exchange current cost data between the mobile memory means and the mobile computer means, and if the client means also comprises a current cost client means operable to retrieve the current cost data.

Furthermore, it is an advantage in this context if the interface means also comprises an operator information means operable to exchange operator information data between the mobile memory means and the mobile computer means, and if the client means also comprises an operator information client means operable to retrieve the operator information data.

A further advantage in this context is achieved if the mobile computer means comprises a display means connected to the client means and operable to display the data from the client means.

Furthermore, it is an advantage in this context if the mobile memory means is a SIM (Subscriber Identity Module) card.

A further advantage in this context is achieved if the cellular network is a public WLAN (Wireless Local Area Network) and if the interface means is operable to exchange authorization keys for the mobile computer means between the mobile memory means and the mobile computer means.

The above mentioned problems are also solved with a method for enabling mobile access according to Claim 10. The method is performed with the aid of a system. The method enables mobile access for a mobile computer means, comprised in the system, to a cellular network or a distributed computer network. The method comprises the steps: to exchange configuration data for the cellular network between a mobile memory means comprised in the system and the mobile computer means; with the aid of a client means comprised in the mobile computer means, to retrieve the configuration data; and with the aid of the mobile computer means, to automatically set up a connection to e.g. the distributed corn outer network.

An advantage with the method according to the present invention is that it makes it possible for a user of the computer to access e.g. the Internet in a predictable way.

A further advantage in this context is achieved if the exchange step is performed with the aid of a configuration means comprised in the interface means, and if the retrieve step is performed with the aid of a configuration client means comprised in the client means.

Furthermore, it is an advantage in this context if the method also comprises the steps: with the aid of a cost plan means comprised in the interface means, to exchange cost plan data between the mobile memory means and the mobile computer means; and with the aid of a cost plan client means comprised in the client means, to retrieve the cost plan data.

By this it will be possible for a user to always be connected independent of location without the need to worry about the cost for accessing e. g. the Internet.

A further advantage in this context is achieved if the method also comprises the steps: with the aid of a current cost means comprised in the interface means, to exchange current cost data between the mobile memory means and the mobile computer means; and with the aid of a current cost client means comprised in the client means, to retrieve the current cost data.

Furthermore, it is an advantage in this context if the method also comprises the steps: with the aid of an operator information means comprised in the interface means, to exchange operator information data between the mobile memory means and the mobile computer means; and with the aid of an operator information client means comprised in the client means, to retrieve the operator information data.

A further advantage in this context is achieved if the method also comprises the step: with the aid of a display means comprised in the mobile computer means, and connected to the client means, to display data from the client means.

Furthermore, it is an advantage in this context if the cellular network is a public WLAN (Wireless Local Area Network), and if the method also comprises the step: to exchange authorization keys for the mobile computer means between the mobile memory means and the mobile computer means.

The above mentioned problems are also solved with at least one computer program product according to Claim 17. The at least one computer program product is/are directly loadable into the internal memory of at least one digital computer, and comprises software code portions for performing the steps of the method according to the present invention when the at least one product is/are run on the at least one computer.

An advantage with this computer program product is that it makes it possible for the user of the computer to access e.g. the Internet in a predictable way.

It will be noted that the term “comprises/comprising” as used in this description is intended to denote the presence of a given characteristic, step or component, without excluding the presence of one or more other characteristic, features, integers, steps, components or groups thereof.

Embodiments of the invention will now be described with a reference to the accompanying drawings, in which:

### BRIEF DESCRIPTION OF THE DRAWINGS

FIG. 1 is a block diagram of the system operable to enable mobile access according to the present invention;

FIG. 2 is a block diagram in more detail of some parts of the system disclosed in FIG. 1;

FIG. 3 is a flow chart of the method for enabling mobile access according to the present invention; and

FIG. 4 schematically shows a number of computer program products according to the present invention.

### DETAILED DESCRIPTION OF THE PREFERRED EMBODIMENTS

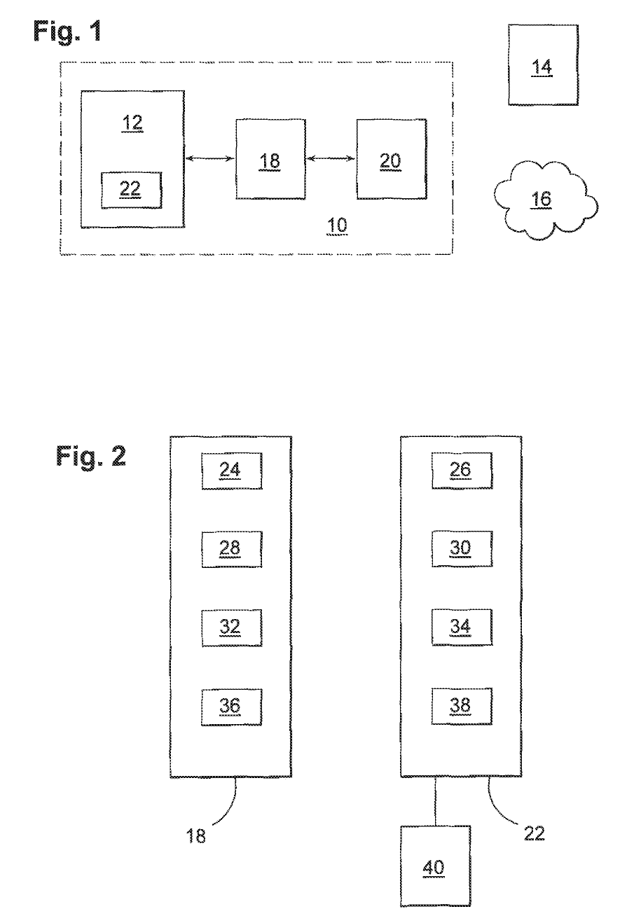

In FIG. 1 there is disclosed a block diagram of the system 10 according to the present invention. The system 10 is operable to enable mobile access for a mobile computer means 12 to a cellular network 14 or a distributed computer network 16. As is apparent in FIG. 1, the mobile computer means 12 is comprised in the system 10. The system 10 also comprises an interface means 18 operable to exchange configuration data for the cellular network 14 between a mobile memory means 20 and the mobile computer means 12. As is apparent in FIG. 1, the mobile memory means 20 is comprised in the system 10. The mobile computer means 12 comprises a client means 22 operable to retrieve the configuration data, whereby the mobile computer means 12 is operable to automatically set up a connection to the distributed computer network 16 or the cellular network 14.

In FIG. 2 there is disclosed a block diagram in more detail of some parts of the system 10 disclosed in FIG. 1. The main parts disclosed in more detail in FIG. 2 are the interface means 18, and the client means 22. As is apparent in FIG. 2, the interface means 18 comprises a configuration means 24 operable to exchange the configuration data. The client means 22 comprises a configuration client means 26 operable to retrieve the configuration data. Furthermore, the interface means 18 comprises a cost plan means 28 operable to exchange cost plan data between the mobile memory means 20 and the mobile computer means 12. The client means 22 also comprises a cost plan client means 30 operable to retrieve the cost plan data.

As also is apparent in FIG. 2, the interface means 18 comprises a current cost means 32 operable to exchange current cost data between the mobile memory means 20 and the mobile computer means 12. The client means 22 comprises a current cost client means 34 operable to retrieve the current cost data. Furthermore, the interface means 18 also comprises an operator information means 36 operable to exchange operator information data between the mobile memory means 20 and the mobile computer means 12. The client means 22 comprises an operator information client means 38 operable to retrieve the operator information data. As also is partly apparent in FIG. 2, the mobile computer means 12 comprises a display means 40 connected to the client means 22. The display means 40 is operable to display the data from the client means 22.

According to one preferred embodiment of the system 10, the mobile memory means 20 is a SIM (Subscriber Identity Module) card 20.

According to another embodiment, the distributed computer network 16 is the Internet 16.

Furthermore, according to another preferred embodiment of the system 10, the cellular network 14 is a public WLAN (Wireless Local Area Network) 14. In that case, the interface means 18 is operable to exchange authorization keys for the mobile computer means 12 between the mobile memory means 20 and the mobile computer means 12.

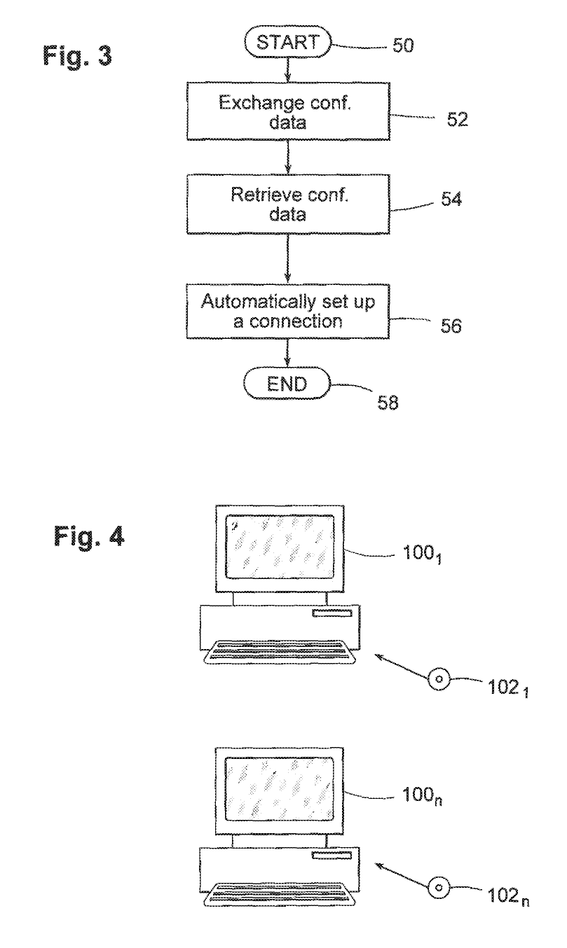

In FIG. 3 there is disclosed a flow chart of a method for enabling mobile access, with the aid of a system 10 (see FIGS. 1, and 2), for a mobile computer means 12, comprised in the system 10, to a cellular network 14 or a distributed computer network 16. The method begins at block 50. Thereafter, the method continues, at block 52, with the step: with the aid of an interface means 18 comprised in the system 10, to exchange configuration data for the cellular network 14 between a mobile memory means 20 comprised in the system 10 and the computer means 12. The method continues, at block 54, with the step: with the aid of a client means 22 comprised in the mobile computer means 12, to retrieve the configuration data. Thereafter, the method continues, at block 56, with the step: with the aid of the mobile computer means 12, to automatically set up a connection to the distributed computer network 16 or to the cellular network 14. The method is completed at block 58.

According to another embodiment of the method according to the present invention, the exchange step is performed with the aid of a configuration means 24 comprised in the interface means 18, and the retrieve step is performed with the aid of a configuration client means 26 comprised in the client means 22.

In a further embodiment of the method, it also comprises the steps: with the aid of a cost plan means 28 comprised in the interface means 18, to exchange cost plan data between the mobile memory means 20 and the mobile computer means 12; and with the aid of a cost plan client means 30 comprised in the client means 22, to retrieve the cost plan data.

According to another embodiment, the method also comprises the steps: with the aid of a current cost means 32 comprised in the interface means 18, to exchange current cost data between the mobile memory means 20 and the mobile computer means 12; and with the aid of a current cost client means 22, to retrieve the current cost data.

In a further embodiment of the method, it also comprises the steps: with the aid of an operator information means 36 comprised in the interface means 18, to exchange operator information between the mobile memory means 20 and the mobile computer means 12; and with the aid of an operator information client means 38 comprised in the client means 22, to retrieve the operator information data.

Furthermore, the method can also comprise the step: with the aid of a display means 40 comprised in the mobile computer means 12, to display data from the client means 22.

In a further embodiment of the method, wherein the cellular network 14 is a public WLAN (Wireless Local Area Network) 14, the method also comprises the step: with the aid of the interface means 18, to exchange authorization keys for the mobile computer means 12 between the mobile memory means 20 and the mobile computer means 12.

In FIG. 4, some computer program products 102₁, . . . , 102ₙ according to the present invention are schematically shown. In FIG. 4, n different digital computers 100₁, . . . , 100ₙ are shown, wherein n is an integer. In FIG. 4, n different computer program products 102₁, . . . , 102ₙ are shown, here in the form of CD discs. The different computer program products 102₁, . . . , 102ₙ are directly loadable into the internal memory of the n different computers 100₁, . . . , 100ₙ. Each computer program product 102₁, . . . , 102ₙ comprises software code portions for performing all the steps according to FIG. 3, when the product/products is/are run on the computers 100₁, . . . , 100ₙ. The computer program products 102₁, . . . , 102ₙ may, for instance, be in the form of diskettes, RAM discs, magnetic tapes, magneto-optical discs or some other suitable products.

In below follows a description of the invention formulated in another way.

The interface means 18 makes it possible for a client means 22 in the computer means 12 to retrieve information such as: Internet configuration; contains information about proxies, access points and similar making it possible for the computer means 12 to automatically set up the Internet connection. Cost plan indication; contains information about the cost of accessing the Internet. For example, if it is a flat rate connection, a virtual fiat rate connection or a non flat rate connection (e.g. the user has to pay for each byte transferred). Current cost; contains for example information about the current amount of spent money. Another example of information that can be presented to the user is, when virtual flat rate is used, where the amount of number of MB left before a non flat rate cost is enabled. Operator information; e.g. the current operator in use is not recommended by the users own operator and the user is therefore recommended to change operator.

The information is sent to the SIM card 20 from the users own operators' network using services such as SMS, USSD, standard DATA connection or similar. Access methods such as SIMOTA can also be applied.

The client means 22 in the computer 12 is the one that is responsible for using the configuration and information stored in the SIM card 20. It is also the client means 22 that is the one that shall present cost plans and similar to the user and inform him/her about the actual cost, which operator that is recommended to use when accessing the Internet. The client means 22 can use the configuration data and set things up using, for example, preferences defined by the user.

The interface means 18 enables information exchange between the computer 12 and the SIM card 20. Today this is only possible to some extent by the use of the AT-command set. There is however no standardized way to exchange higher level information and the AT-commands allows for things like dialling numbers and similar.

Possible implementations can be as follows:

Reuse the standard AT-dialog and overlay this dialog with the higher level protocol. This means that the SIM card 20 is connected to the modem and that the computer 12 communicates using the serial port between the modem and the computer 12. The modem then relays the information to the SIM card 20. The higher level protocol can be encoded in a format that is suitable for the AT-dialog command set.

The computer 12 is connected to the SIM card 20 directly via a serial bus that allows for information exchange. There is however a need in this case to also have a secure communication path between the SIM card 20 and the modem in order to allow call-setup for the modem. In this case both software and hardware changes are needed.

The information that are accessible on the SIM card 20 can appear there using different means, as follows:

When the SIM card 20 is set up (during provisioning at operator site), configuration data that the present invention describes can be stored on the SIM card 20.

At normal operation, e.g. the subscriber is connected to the operator and the “network” (the DMS system or similar). The DMS system notice that the configuration data must be updated and initiates this update. This update can be performed using different means, for example:

A set of SMS:s are sent.

A USSD session is set up and the data are sent using this session.

An OMA-DM session is set up and the data are sent using that session.

The invention is not limited to the described embodiments. It will be evident for those skilled in the art that many different modifications are feasible within the scope of the following Claims.

1. A system operable to enable mobile access for a mobile computer means, comprised in said system, to a cellular network or a distributed computer network, characterized in that said system also comprises an interface means operable to exchange configuration data for said cellular network between a mobile memory means comprised in said system and said mobile computer means, and in that said mobile computer means comprises a client means operable to retrieve said configuration data, whereby said mobile computer means is operable to automatically set up a connection to said distributed computer network or said cellular network.

2. A system operable to enable mobile access for a mobile computer means according to claim 1, characterized in that said interface means comprises a configuration means operable to exchange said configuration data, and in that said client means comprises a configuration client means operable to retrieve said configuration data.

3. A system operable to enable mobile access for a mobile computer means according to claim 1, characterized in that said interface means also comprises a cost plan means operable to exchange cost plan data between said mobile memory means and said mobile computer means, and in that said client means also comprises a cost plan client means operable to retrieve said cost plan data.

4. A system operable to enable mobile access for a mobile computer means according to claim 1, characterized in that said interface means also comprises a current cost means operable to exchange current cost data between said mobile memory means and said mobile computer means, and in that said client means also comprises a current cost client means operable to retrieve said current cost data.

5. A system operable to enable mobile access for a mobile computer means according to claim 1, characterized in that said interface means also comprises an operator information means operable to exchange operator information data between said mobile memory means and said mobile computer means, and in that said client means also comprises an operator information client means operable to retrieve said operator information data.

6. A system operable to enable mobile access for a mobile computer means according to claim 1, characterized in that said mobile computer means comprises a display means connected to said client means, and operable to display said data from said client means.

7. A system operable to enable mobile access for a mobile computer means according to claim 1, characterized in that said mobile memory means is a SIM (Subscriber Identity Module) card.

8. A system operable to enable mobile access for a mobile computer means according to claim 1, characterized in that said distributed computer network is the Internet.

9. A system operable to enable mobile access for a mobile computer means according to claim 1, characterized in that said cellular network is a public WLAN (Wireless Local Area Network), and in that said interface means is operable to exchange authorization keys for said mobile computer means between said mobile memory means and said mobile computer means.

10. A method for enabling mobile access, with the aid of a system, for a mobile computer means, comprised in said system, to a cellular network or a distributed computer network, characterized in that said method comprises the steps: with the aid of an interface means comprised in said system, to exchange configuration data for said cellular network between a mobile memory means comprised in said system and said mobile computer means; with the aid of a client means comprised in said mobile computer means, to retrieve said configuration data; and with the aid of said mobile computer means, to automatically set up a connection to said distributed computer network or said cellular network.

11. A method for enabling mobile access for a mobile computer means according to claim 10, characterized in that said exchange step is performed with the aid of a configuration means comprised in said interface means, and in that said retrieve step is performed with the aid of a configuration client means comprised in said client means.

12. A method for enabling mobile access for a mobile computer means according to claim 10, characterized in that said method also comprises the steps: with the aid of a cost plan means comprised in said interface means, to exchange cost plan data between said mobile memory means and said mobile computer means; and with the aid of a cost plan client means comprised in said client means, to retrieve said cost plan data.

13. A method for enabling mobile access for a mobile computer means according to claim 10, characterized in that said method also comprises the steps: with the aid of a current cost means comprised in said interface means, to exchange current cost data between said mobile memory means and said mobile computer means; and with the aid of a current cost client means comprised in said client means, to retrieve said current cost data.

14. A method for enabling mobile access for a mobile computer means according to claim 10, characterized in that said method also comprises the steps: with the aid of an operator information means comprised in said interface means, to exchange operator information data between said mobile memory means and said mobile computer means; and with the aid of an operator information client means comprised in said client means, to retrieve said operator information data.

15. A method for enabling mobile access for a mobile computer means according to claim 10, characterized in that said method also comprises the step: with the aid of a display means comprised in said mobile computer means and connected to said client means, to display data from said client means.

16. A method for enabling mobile access for a mobile computer means according to claim 10, characterized in that said cellular network is a public WLAN (Wireless Local Area Network), and in that said method also comprises the step: with the aid of said interface means, to exchange authorization keys for said mobile computer means between said mobile memory means and said mobile computer means.

17. At least one computer program product (102₁, . . . , 102ₙ) directly loadable into the internal memory of at least one digital computer (100₁, . . . , 100ₙ), comprising software code portions for performing the steps of claim 10 when said at least one product (102₁, . . . , 102ₙ) is/are run on said at least one computer (100₁, . . . , 100ₙ).
